(19) United States
(12) Patent Application Publication
(10) Pub. No.: US 2013/0300725 A1
(43) Pub. Date: Nov. 14, 2013

(54) ORGANIC LIGHT EMITTING DISPLAY DEVICE AND DRIVING METHOD THEREOF

(71) Applicant: Jin-Tae Jeong, Yongin-city (KR)

(72) Inventor: Jin-Tae Jeong, Yongin-city (KR)

(21) Appl. No.: 13/589,032

(22) Filed: Aug. 17, 2012

(30) Foreign Application Priority Data
May 10, 2012 (KR) 10-2012-0049723

(51) Int. Cl. G09G 3/32

(52) U.S. Cl. 345/212; 345/76

(57) ABSTRACT

An organic light emitting display device capable of improving display quality and a driving method of the organic light emitting display device are provided. The organic light emitting display device includes pixel circuits and organic light emitting diodes (OLEDs) each in pixel regions defined by scan lines and data lines, and a switching unit in one of the pixel regions and coupled between one of the pixel circuits and a plurality of the OLEDs from different ones of the pixel regions. The driving method includes charging pixel circuits with voltages corresponding to data signals, and alternately coupling each of the pixel circuits to different ones of a plurality of organic light emitting diodes (OLEDs) from different pixel regions defined by scan lines and data lines.

### CROSS-REFERENCE TO RELATED APPLICATION

This application claims priority to and the benefit of Korean Patent Application No. 10-2012-0049723, filed on May 10, 2012, in the Korean Intellectual Property Office, the entire content of which is incorporated herein by reference.

### BACKGROUND

1. Field

Aspects of embodiments of the present invention relate to an organic light emitting display device and a driving method of the organic light emitting display device.

2. Description of the Related Art

Recently, various flat panel display devices capable of reducing weight and volume when compared to cathode ray tube display devices have been developed. Examples of flat panel display devices include a liquid crystal display (LCD), a field emission display (FED), a plasma display panel (PDP), an organic light emitting display device, and the like.

Among the flat panel display devices, the organic light emitting display device displays an image using organic light emitting diodes (OLEDs) generating light by recombination of electrons and holes. The organic light emitting display device can be driven at a rapid response speed and with low power consumption.

For example, an organic light emitting display device may include pixels arranged in a matrix form. Each of the pixels controls a current amount that is supplied to the OLED corresponding to a data signal, thereby displaying an image. Each of the pixels may include a plurality of transistors.

The transistors generally include a semiconductor layer (which includes a source region, a drain region, and a channel region), a gate electrode, a source electrode, and a drain electrode. The semiconductor layer may be formed, for example, of polycrystalline silicon (Poly-si) or amorphous silicon (a-si). For instance, in many organic light emitting display devices, polycrystalline silicon having high electron mobility is used as the semiconductor layer.

### SUMMARY

Aspects of embodiments of the present invention relate to an organic light emitting display device and a driving method of the organic light emitting display device. Embodiments of the present invention provide an organic light emitting display device capable of improving display quality and a driving method of the organic light emitting display device.

In an exemplary embodiment of the present invention, an organic light emitting display device is provided. The organic light emitting display device includes pixel circuits and organic light emitting diodes (OLEDs) each in pixel regions defined by scan lines and data lines, and a switching unit in one of the pixel regions and coupled between one of the pixel circuits and a plurality of the OLEDs from different ones of the pixel regions.

The one of the pixel circuits may be configured to supply current corresponding to a data signal supplied from one of the data lines to the switching unit.

One of the plurality of the OLEDs may be in the one of the pixel regions.

The plurality of the OLEDs may be coupled to different ones of the scan lines.

The plurality of the OLEDs may be coupled to a same one of the scan lines.

The switching unit may include j switches, j being a natural number greater than one, the j switches being coupled to different ones of the plurality of the OLEDs.

The j switches may be configured to alternately turn on corresponding to control signals supplied from j control lines.

The organic light emitting display device may further include a control line driving unit for supplying the control signals.

The control line driving unit may be configured to supply the control signals to the j control lines without overlap.

The control line driving unit may be configured to supply the control signals alternately in consecutive frame units.

The organic light emitting display device may further include a scan driving unit for supplying a scan signal to the scan lines, a data driving unit for supplying data signals that are generated from data to the data lines, and a timing control unit for controlling the scan driving unit, the data driving unit, and the control line driving unit.

The timing control unit may be configured to arrange the data to correspond to the control signals.

According to another exemplary embodiment of the present invention, a driving method of an organic light emitting display device is provided. The driving method includes charging pixel circuits with voltages corresponding to data signals, and alternately coupling each of the pixel circuits to different ones of a plurality of organic light emitting diodes (OLEDs) from different pixel regions defined by scan lines and data lines.

Each of the pixel circuits may be coupled to the different ones of the OLEDs in consecutive frame units.

According to an embodiment of an organic light emitting display device and a driving method of the organic light emitting display device, each of the pixel circuits supplies current to a plurality of OLEDs, and therefore displays an image having more uniform luminescence.

### BRIEF DESCRIPTION OF THE DRAWINGS

The accompanying drawings, together with the specification, illustrate exemplary embodiments of the present invention, and, together with the description, serve to explain aspects and principles of the present invention.

FIG. 1 is a diagram illustrating an organic light emitting display device according to an embodiment of the present invention.

FIG. 2 is a diagram illustrating an embodiment of pixels shown in FIG. 1.

FIG. 3 is a diagram illustrating an embodiment of switching units shown in FIG. 2.

FIG. 4 is a diagram illustrating another embodiment of the switching units shown in FIG. 2.

FIG. 5 is a diagram illustrating yet another embodiment of the switching units shown in FIG. 2.

### DETAILED DESCRIPTION

Hereinafter, certain exemplary embodiments according to the present invention will be described with reference to the accompanying drawings. Here, when a first element is described as being coupled to a second element, the first element may be directly coupled (e.g., connected) to the second element or may be indirectly coupled (e.g., electrically connected) to the second element via one or more third elements. Further, some of the elements that are not essential to a complete understanding of the embodiments may be omitted for clarity. In addition, like reference numerals refer to like elements throughout.

In an exemplary embodiment of the present invention, an organic light emitting display device having pixels that include transistors formed with a polycrystalline silicon semiconductor layer is provided. The polycrystalline silicon may be generated, for example, by providing amorphous silicon on a substrate and then crystallizing it. For example, excimer laser annealing (ELA) may be used to crystallize the amorphous silicon. The ELA method crystallizes the amorphous silicon into polycrystalline silicon by irradiating the amorphous silicon with a laser.

Such a process for crystallizing amorphous silicon into polycrystalline silicon may have a large effect on the transistor characteristics such as mobility and threshold voltage. For example, when the laser is not uniformly radiated onto the amorphous silicon, the resulting circuits, such as transistors and capacitors, may exhibit varying characteristics. These variations may not be possible or practical to prevent.

Such variations in the transistors and capacitors may be different for every pixel, and therefore, light having different luminescence may be generated in each of the pixels even when the same data signal is applied. For example, some pixels may generate darker light than other pixels, even when driven by the same data signal. This may lead to blurred images or other display quality problems (that lead to degraded display quality as perceived by an observer) in the resulting organic light emitting display device.

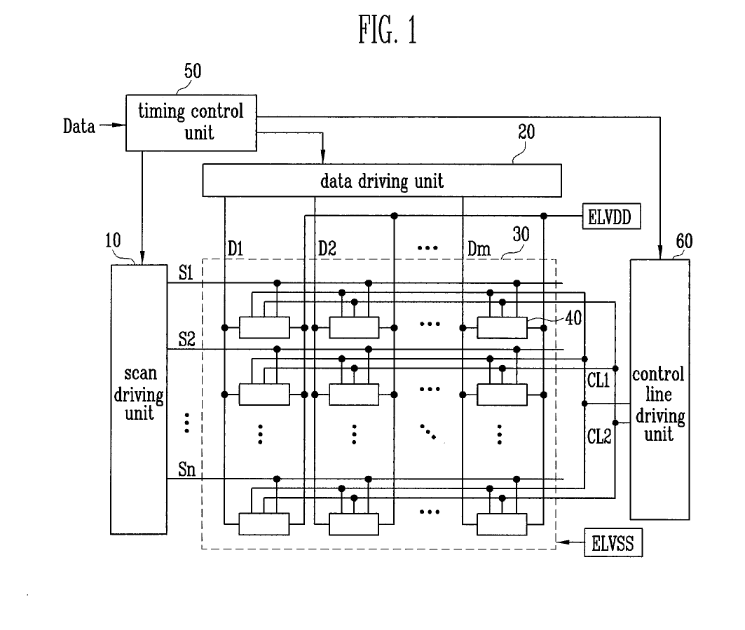

Embodiments that may be understood and practiced by those skilled in the art and that may reduce or minimize problems such as these will be described in detail with reference to accompanying FIGS. 1 to 5 as follows.

FIG. 1 is a diagram illustrating an organic light emitting display device according to an embodiment of the present invention.

Referring to FIG. 1, the organic light emitting display device includes a display unit 30 including pixels 40 formed in pixel regions that are defined by (for example, partitioned by) scan lines S1 to Sn and data lines D1 to Dm, a scan driving unit 10 for driving the scan lines S1 to Sn, a data driving unit 20 for driving the data lines D1 to Dm, a control line driving unit 60 for driving control lines CL (for example, for driving a first control line CL1 and a second control line CL2) each coupled to the pixels 40, and a timing control unit 50 for controlling the scan driving unit 10, the data driving unit 20, and the control line driving unit 60.

The display unit 30 supplies a first power ELVDD and a second power ELVSS that are supplied from outside to the pixels 40. Each of the pixels 40 that are supplied with the first power ELVDD and the second power ELVSS supply a set current (e.g., a predetermined current) corresponding to a data signal to an OLED. To this end, each of the pixels 40 includes a pixel circuit (see, for example, pixel circuit 42 in FIGS. 2-5) for supplying current corresponding to the data signal. The pixel circuit is coupled to a plurality of OLEDs, and supplies the current to any one of the OLEDs depending on a control signal that is supplied from the control line driving unit 60. This will be described in further detail below.

The scan driving unit 10 supplies the scan signal to the scan lines S1 to Sn. For example, the scan driving unit 10 sequentially supplies the scan signal to the scan lines S1 to Sn and selects the pixels 40 based on horizontal lines (e.g., rows).

The data driving unit 20 supplies the data signals to the data lines D1 to Dm concurrently (for example, synchronized) with the scan signal. Then, the data signals are supplied to those ones of the pixels 40 that are selected by the scan signal.

The control line driving unit 60 supplies the control signal to the control lines CL. As an example, the control line driving unit 60 supplies a first control signal to the first control line CL1 and supplies a second control signal to the second control line CL2. For instance, in an exemplary embodiment, the control signals that are supplied from the control line driving unit 60 to the control lines CL do not overlap each other.

The timing control unit 50 controls the scan driving unit 10, the data driving unit 20, and the control line driving unit 60 corresponding to synchronization signals and data that are supplied from outside. Further, the timing control unit 50 may rearrange the data corresponding to a coupling structure (described in further detail below) between the pixel circuits and the OLEDs, and then supplies the rearranged data to the data driving unit 20. The coupling structure can be controlled using the control signal supplied to the control lines CL.

As an example, when each of the pixel circuits is coupled to the OLED located in the same pixel region (which may be thought of as a standard coupling structure), the timing control unit 50 supplies the data to the data driving unit 20 by arranging the data to correspond to this standard coupling structure. In contrast, when each of the pixel circuits is coupled to the OLED located in an adjacent pixel region (for example, the pixel region to the left, right, above, or below), the timing control unit 50 supplies the data to the data driving unit 20 by arranging the data to correspond to this different coupling structure. In the above described embodiment, the timing control unit 50 performs this data arranging. The present invention, however, is not limited thereto. For instance, in other embodiments, the data driving unit 20 may perform some or all of this data arranging.

FIG. 2 is a diagram illustrating an embodiment of the pixels 40 shown in FIG. 1.

Three such pixels 40, each having their own pixel region, are illustrated in FIG. 2. Referring to FIG. 2, each of the pixels 40 includes a pixel circuit 42, a switching unit 44, and an OLED provided in the pixel region.

The OLED generates light having a set luminescence (e.g., a predetermined luminescence) corresponding to an amount of current that is supplied from one of the pixel circuits 42. Here, the OLED is coupled to any one of a plurality of pixel circuits 42 via the switching units 44. For example, the OLED may be sequentially coupled to the plurality of pixel circuits 42, that is, coupled to adjacent ones of the plurality of pixel circuits 42. For instance, the OLED may be coupled to a different one of the pixel circuits 42 from one frame unit to the next frame unit.

The pixel circuit 42 is charged with a set voltage (e.g., a predetermined voltage) corresponding to the data signal which is supplied from the data line D (for example, one of the data lines D1, D2, . . . ) when the scan signal is supplied to the scan line S (for example, the scan line Sn). The pixel circuit 42 that is charged with the voltage corresponding to the data signal supplies current to any one OLED of the plurality of OLEDs to which it is coupled via the switching unit 44. To this end, the pixel circuit 42 includes at least one transistor and capacitor, and may be configured in various forms of circuits that are known to those of ordinary skill in the art.

The switching unit 44 is electrically connected to the pixel circuit 42 located in the same pixel region. Each of the switching units 44 is electrically connected to the OLED located in the same pixel region, and to one or more OLEDs in other pixel regions (for example, neighboring pixel regions). The switching unit 44 couples any one of this plurality of OLEDs to the pixel circuit 42 corresponding to the control signals that are supplied from the control lines CL.

For example, the control signals may be set such that the switching unit 44 couples the pixel circuit 42 to different OLEDs depending on the frame unit. For example, the switching unit 44 may electrically connect the OLED and the pixel circuit 42 that are located in the same pixel region when the first control signal is supplied from the first control line (CL1), and electrically connect the OLED and the pixel circuit 42 that are located in different pixel regions when the second control signal is supplied from the second control line (CL2). Here, when the first control signal and the second control signal are alternately supplied in consecutive frame units, then the current that is supplied from any specific pixel circuit 42 is supplied to different OLEDs in consecutive frame units. In this case, the characteristics of at least two pixel circuits 42 are averaged and reflected in the light that is generated from each of the OLEDs, and as a result, a luminescence variation between the pixels 40 may be reduced or minimized.

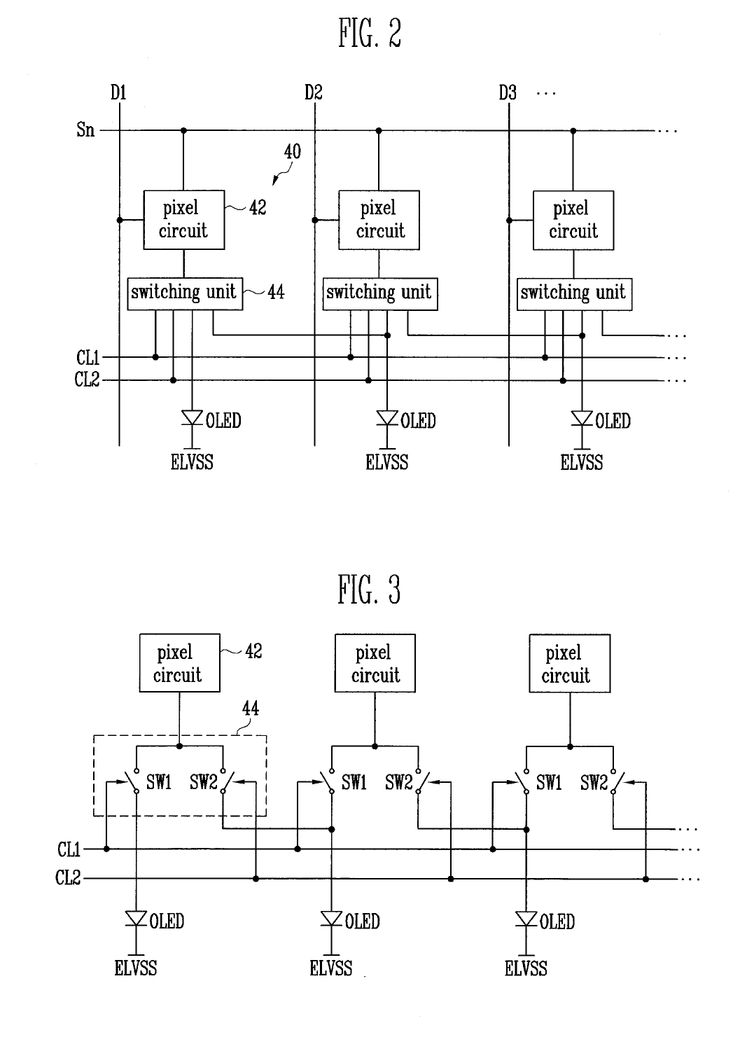

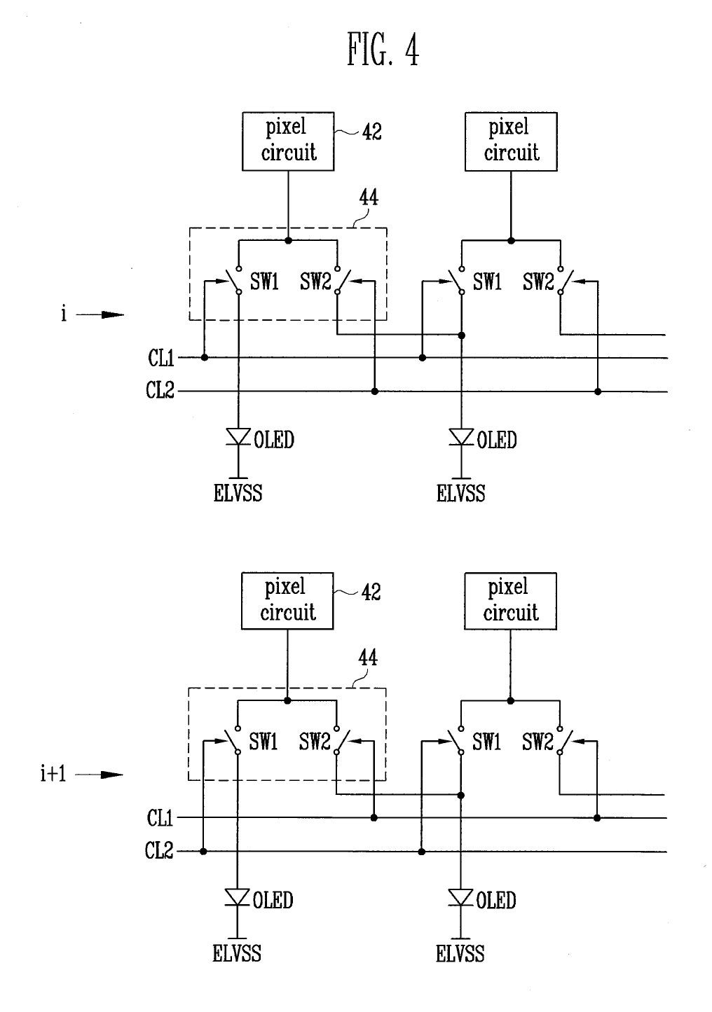

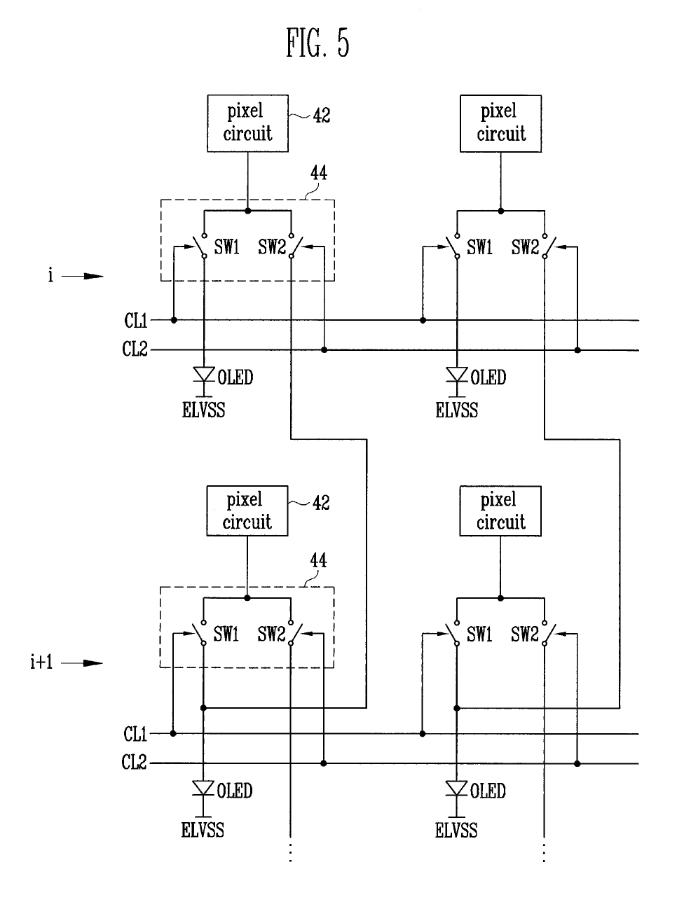

FIG. 3 is a diagram illustrating an embodiment of the switching units shown in FIG. 2. FIG. 4 is a diagram illustrating another embodiment of the switching units shown in FIG. 2.

Referring to FIG. 3, the switching unit 44 includes a first switch SW1 and a second switch SW2. The first switch SW1 is coupled between the pixel circuit 42 and the OLED that is located in the same pixel region. The second switch SW2 is coupled between the pixel circuit 42 and the OLED that is located in an adjacent pixel region (in this case, the pixel region to the right of the switching unit 44).

The first switch SW1 is turned on when the first control signal is supplied from the control line CL1, and thereby electrically connects the OLED and the pixel circuit 42 that are located in the same pixel region. The second switch SW2 is turned on when the second control signal is supplied from the second control line CL2, and thereby electrically connects the OLED and the pixel circuit 42 that are located in different (and in this case, adjacent) pixel regions.

Here, when the first control signal and the second control signal are supplied in alternating frame units, each specific OLED is supplied with current from different ones of the pixel circuits 42 in the alternating frame units. In this case, the light that is generated from the specific OLED is obtained by averaging characteristics of different pixel circuits 42 overall multiple frame units, and therefore is capable of reducing or minimizing luminescence variation and the like.

FIG. 3 shows the two switches SW1, SW2 being included in the switching unit 44. However, the present invention is not limited thereto. In other embodiments, the switching unit 44 may include j (j is a natural number of 2 or more) switches SW. The j switches SW that are included in the switching unit 44 are coupled to each of j OLEDs, and may, for example, be sequentially turned on corresponding to the control signal that is supplied from j control lines CL. In this case, each of the OLEDs is supplied with current from j different ones of the pixel circuits 42, and therefore is capable of reducing or minimizing the luminescence variation and the like.

Additionally, FIG. 3 shows the first switch SW1 being coupled to the first control line CL1, and the second switch SW2 being coupled to the second control line CL2. However, the present invention is not limited thereto. For example, as shown in FIG. 4, in the i-th (i is a natural number, for instance an even number) horizontal line, the first switch SW1 is coupled to the first control line CL1, and the second switch SW2 is coupled to the second control line CL2. In the i+1-th (for instance, an odd number) horizontal line, the first switch SW1 is coupled to the second control line CL2, and the second switch SW2 is coupled to the first control line CL1.

In embodiments of the present invention, a variety of forms of coupling methods may be applied for coupling the plurality of OLEDs to the switching unit 44. Further, additional pixel circuits 42 and corresponding switching units 44 may be provided in additional columns (with additional corresponding data lines) or rows (with additional corresponding scan lines) to supply current to, for example, OLEDs located at edges of the display unit 30 (for example, to OLEDs that would otherwise not have corresponding adjacent pixel circuits 42 and switching units 44).

FIG. 5 is a diagram illustrating yet another embodiment of the switching units shown FIG. 2.

Referring to FIG. 5, the switching unit 44 includes the first switch SW1 and the second switch SW2. The first switch SW1 is coupled between the pixel circuit 42 and the OLED that are located in the same pixel region. The second switch SW2 is coupled between the pixel circuit 42 and the OLED that is located on another horizontal line (for example, a neighboring horizontal line).

In further detail, the first switch SW1 and the second switch SW2 that are included in the switching unit 44 of FIG. 3 are coupled to different OLEDs that are located on the same horizontal line. However, the first switch SW1 and the second switch SW2 that are included in the switching unit 44 of FIG. 5 are coupled to OLEDs that are located on different horizontal lines. In FIG. 5, the first switch SW1 is coupled to the OLED that is located on the i-th horizontal line, and the second switch SW2 is coupled to the OLED that is located on the i+1-th horizontal line and in the same column (i.e., shares the same data line) as the other OLED. In this case, each of the OLEDs is alternately coupled to the pixel circuits 42 that are located on different horizontal lines, and are therefore capable of reducing or preventing the generating of degraded image quality based on vertical line.

In embodiments of the present invention, the switching unit 44 may be coupled to the plurality of OLEDs that are located, for example, in upper/below/left/right pixel regions in various forms, or in nonadjacent pixel regions. That is, the switching unit 44 may be configured in various forms so that each of the OLEDs may be coupled to a plurality of pixel circuits 42.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display device, comprising:
pixel circuits and organic light emitting diodes (OLEDs) each in pixel regions defined by scan lines and data lines; and
a switching unit in one of the pixel regions and coupled between one of the pixel circuits and a plurality of the OLEDs from different ones of the pixel regions.

2. The organic light emitting display device according to claim 1, wherein the one of the pixel circuits is configured to supply current corresponding to a data signal supplied from one of the data lines to the switching unit.

3. The organic light emitting display device according to claim 1, wherein one of the plurality of the OLEDs is in the one of the pixel regions.

4. The organic light emitting display device according to claim 1, wherein the plurality of the OLEDs are coupled to different ones of the scan lines.

5. The organic light emitting display device according to claim 1, wherein the plurality of the OLEDs are coupled to a same one of the scan lines.

6. The organic light emitting display device according to claim 1, wherein the switching unit comprises j switches, j being a natural number greater than one, the j switches being coupled to different ones of the plurality of the OLEDs.

7. The organic light emitting display device according to claim 6, wherein the j switches are configured to alternately turn on corresponding to control signals supplied from j control lines.

8. The organic light emitting display device according to claim 7, further comprising a control line driving unit for supplying the control signals.

9. The organic light emitting display device according to claim 8, wherein the control line driving unit is configured to supply the control signals to the j control lines without overlap.

10. The organic light emitting display device according to claim 8, wherein the control line driving unit is configured to supply the control signals alternately in consecutive frame units.

11. The organic light emitting display device according to claim 8, further comprising:
a scan driving unit for supplying a scan signal to the scan lines;
a data driving unit for supplying data signals that are generated from data to the data lines; and
a timing control unit for controlling the scan driving unit, the data driving unit, and the control line driving unit.

12. The organic light emitting display device according to claim 11, wherein the timing control unit is configured to arrange the data to correspond to the control signals.

13. A driving method of an organic light emitting display device, comprising:
charging pixel circuits with voltages corresponding to data signals; and
alternately coupling each of the pixel circuits to different ones of a plurality of organic light emitting diodes (OLEDs) from different pixel regions defined by scan lines and data lines.

14. The method according to claim 13, wherein each of the pixel circuits is coupled to the different ones of the OLEDs in consecutive frame units.
